(19) United States
(12) Patent Application Publication
(10) Pub. No.: US 2014/0182326 A1
(43) Pub. Date: Jul. 3, 2014

(54) Heat Exchanger For A Heating, Ventilation And/Or Air-Conditioning Unit

(71) Applicants: Mohamed Yahia, Paris (FR); Bertrand Nicolas, Paris (FR)

(72) Inventors: Mohamed Yahia, Paris (FR); Bertrand Nicolas, Paris (FR)

(73) Assignee: Valeo Systemes Thermiques, Le Mesnil Saint Denis Cedex (FR)

(21) Appl. No.: 14/113,010

(22) PCT Filed: Apr. 20, 2012
(86) PCT No.: PCT/EP2012/001708

§ 371 Date: Mar. 10, 2014

(30) Foreign Application Priority Data
Apr. 21, 2011 (FR) 11/01242

(51) Int. Cl. F28F 1/00; B60H 1/32; F24F 5/00

(52) U.S. Cl. CPC F28F 1/00; F24F 5/001; B60H 1/3227
USPC 62/498; 165/104.19; 454/156

(57) ABSTRACT

The invention relates to a heat exchanger (1) arranged to perform a heat exchange between a coolant (2) and an internal air flow (3) and comprising a bundle (8) formed by a first layer (4) and a second layer (6) through which the coolant flows, said first layer (4) being defined by a first front face (5a) and a second front face (5b) and said second layer (6) being defined by a third front face (5c) and a fourth front face (5d). At least three of the front faces (5a, 5b, 5c, 5d) are different and arranged in different planes.

The technical field of the present invention is that of heat exchangers integrated into an air-conditioning loop, in particular a reversible air-conditioning loop. More particularly, the invention relates to a heat exchanger between a stream of interior air, intended to be distributed in a passenger compartment of a vehicle, and the coolant fluid.

A motor vehicle is conventionally equipped with an air-conditioning loop within which a coolant fluid circulates. The air-conditioning loop comprises, in particular, a compressor, an exterior heat exchanger, an expansion member and an interior heat exchanger, through which the coolant fluid flows. The interior heat exchanger is installed in a housing of a heating, ventilation and/or air-conditioning installation, generally disposed in a passenger compartment of the vehicle, in order to distribute a stream of interior air which is hot or cold or temperature-controlled depending on the requirements of a user of the vehicle. The exterior heat exchanger is, for its part, conventionally installed along the front face of the vehicle in order to be passed through by a stream of exterior air with respect to the passenger compartment of the vehicle.

The air-conditioning loop may be used in various operating modes, in particular in what is known as a “cooling” mode or in what is known as a “heating” mode. Such an air-conditioning loop is also known as a “reversible air-conditioning loop” or “heat pump air-conditioning loop”.

In what is known as the “cooling” mode, the coolant fluid is circulated by the compressor toward the exterior heat exchanger, operating as a condenser or gas cooler, in which it is cooled by the stream of exterior air. Next, the coolant fluid circulates toward the expansion member, in which it undergoes a drop in pressure before entering the interior heat exchanger, operating as an evaporator. The coolant fluid, passing through the interior heat exchanger, is then heated by the stream of interior air entering the housing of the heating, ventilation and/or air-conditioning installation, resulting in corresponding cooling of the stream of interior air in order to lower the temperature of the passenger compartment of the vehicle. Since the air-conditioning loop is a closed-loop circuit, the coolant fluid then returns toward the compressor.

In what is known as the “heating” mode, the coolant fluid is circulated by the compressor toward the interior heat exchanger. The interior heat exchanger then acts as a condenser or gas cooler, in the coolant fluid is cooled by the stream of interior air circulating in the housing of the heating, ventilation and/or air-conditioning installation. The stream of interior air is heated in contact with the interior heat exchanger in order to increase the temperature in the passenger compartment of the vehicle. After passing through the interior heat exchanger, the coolant fluid is expanded by the expansion member before arriving in the exterior heat exchanger, operating as an evaporator. The stream of exterior air contributes toward the vaporization of the coolant fluid before it returns toward the compressor.

Such an air-conditioning loop has been improved by the addition of a second interior heat exchanger intended to transfer the calories of the coolant fluid toward the stream of interior air intended to be distributed in the passenger compartment of the vehicle. The second interior heat exchanger thus heats the stream of interior air when the air-conditioning loop operates in what is known as the “heating” mode.

However, such a second interior heat exchanger is not optimized. This is because the compressor has to exert significant effort, resulting in an increase in the power consumed. The coefficient of performance of the air-conditioning loop used in what is known as the “heating” mode is thus not optimized.

Furthermore, such a second interior heat exchanger is installed in the housing of the heating, ventilation and/or air-conditioning installation so as to be passed through by the stream of interior air intended to be distributed in the passenger compartment. For reasons of thermal comfort of the occupants of the vehicle, it is necessary to supply a homogeneous temperature of the stream of interior air. However, the second interior heat exchanger is not configured to ensure such thermal uniformity of the stream of interior air passing through it.

Thus, the aim of the present invention is to resolve the drawbacks described above mainly by proposing a heat exchanger such that the coolant fluid moves in two distinct, advantageously parallel rows. The heat exchanger comprises a phase separation means in which the coolant fluid collects in the liquid state. The phase separation means is installed such that one of the two rows supercools the coolant fluid, that is to say lowers the temperature of the coolant fluid when the latter is in the liquid state. It will be understood here that the other row condenses the coolant fluid, during which the coolant fluid is cooled and/or condensed. During this step, the coolant fluid tends toward its saturation point. The arrangement of the two rows, or layers, makes it possible to homogenize the temperature of the stream of interior air passing through the interior heat exchanger.

The subject of the invention is thus a heat exchanger designed to carry out heat exchange between a coolant fluid and a stream of interior air. More specifically, the heat exchanger comprises a bundle formed by a first layer and a second layer in which the coolant fluid circulates. The first layer is delimited by a first front face and a second front face. The second layer is delimited by a third front face and a fourth front face. In addition, according to the present invention, at least three of the front faces are distinct and arranged in different planes.

Advantageously, a phase separation means connects the first layer and the second layer of the heat exchanger.

Such an arrangement makes it possible to increase the coefficient of performance of an air-conditioning loop incorporating such a heat exchanger, operating in what is known as a “heating” mode. This is because the phase separation means forces the second layer to be fed with the coolant fluid in the liquid phase. Since the second layer exchanges has a large heat exchange area, the level of supercooling, that is to say the lowering of the temperature of the coolant fluid in the liquid phase following its condensation, is increased.

Advantageously, the heat exchanger comprises a bundle formed by the connection of the first layer to the second layer.

Preferably, the first layer extends over a first depth and the second layer extends over a second depth. Preferably, the second depth is less than the first depth. The sum of the first depth of the first layer and of the second depth of the second layer, defining the depth of the bundle, is between 20 and 50 mm.

Moreover, the heat exchanger is such that a height of the first layer is identical to a height of the second layer and/or in which a width of the first layer is identical to a width of the second layer. Advantageously, the height of the first layer and/or of the second layer is between 120 and 300 mm. Also advantageously, the width of the first layer and/or of the second layer is between 100 and 300 mm.

The abovementioned dimensions are particularly suitable for the integration of such a heat exchanger inside a housing of a heating, ventilation and/or air-conditioning installation of a motor vehicle passenger compartment.

As defined, the first depth, the height and the width of the first layer define a first internal volume, and the second depth, the height and the width of the second layer define a second internal volume. Preferably, the second internal volume of the second layer is between 30% and 40% of the first internal volume of the first layer.

In addition, the heat exchanger advantageously comprises a phase separation means connecting the first layer and the second layer of the heat exchanger.

More specifically, the first layer comprises a plurality of tubes defining a first volume of coolant fluid and a plurality of inserts defining a first heat exchange volume. Similarly, the second layer comprises a plurality of tubes defining a second volume of coolant fluid and a plurality of inserts defining a second heat exchange volume. According to this arrangement, the first volume of coolant fluid is placed in communication with the second volume of coolant fluid via the phase separation means.

Preferably, the first layer has an outlet orifice connected to the phase separation means and the second layer has an inlet orifice connected to the phase separation means.

According to another feature of the invention, the phase separation means comprises a collection zone intended to receive the coolant fluid in the liquid state, the inlet orifice of the second layer being connected to the collection zone. This is understood as meaning that the collection zone communicates with the second layer.

It has been shown that according to the present invention, since the second layer is connected to the phase separation means, it is possible to produce a difference in temperature of the coolant fluid between the inlet orifice and an outlet of the second layer of at least 30° C. when a difference in temperature between the stream of interior air passing through the second layer and the coolant fluid channeled in the second layer is greater than or equal to 50° C.

According to yet another feature of the invention, the heat exchanger comprises a coolant fluid inlet pipe and a coolant fluid outlet pipe which are formed on one and the same side of the heat exchanger.

According to a complementary aspect of the invention, the phase separation means and the second volume of coolant fluid of the second layer delimit together an internal volume of between 40 cm³ and 50 cm³.

It will be understood from such an arrangement that the phase separation means is not designed to store the non-circulating mass of coolant fluid, such a function being ensured by an additional storage means disposed in the air-conditioning loop incorporating the heat exchanger according to the present invention.

The present invention also relates to a heating, ventilation and/or air-conditioning installation for a motor vehicle, comprising a housing able to channel a stream of interior air intended to be distributed in a passenger compartment of the vehicle. The heating, ventilation and/or air-conditioning installation comprises a heat exchanger as defined above. Advantageously, the heat exchanger is installed in the housing in order to be passed through by the stream of interior air.

Preferably, the heat exchanger is installed in the housing such that the stream of interior air passes through the second layer before passing through the first layer. In other words, the stream of interior air passes into the supercooling layer (second layer), and while passing through the latter the stream of interior air is preheated. Next, the stream of interior air passes through the cooling and/or condensation layer (first layer). The coolant fluid is thus cooled in the liquid state, this contributing to increasing the coefficient of performance of the thermodynamic cycle which takes place in the air-conditioning loop using such a heat exchanger.

Finally, the invention covers an air-conditioning loop for a motor vehicle, comprising a compressor, an exterior heat exchanger, a means for storing coolant fluid, an interior heat exchanger and at least one expansion member, comprising a heat exchanger as defined above and a phase separation means connecting the first layer and the second layer of the heat exchanger.

A very first advantage according to the invention lies in the increase in the coefficient of performance of the air-conditioning loop when the latter is used in what is known as the “heating” mode making it possible to heat the stream of interior air intended to be distributed in the passenger compartment.

Another advantage lies in the production of a stream of hot interior air, the temperature of which is homogeneous and uniform.

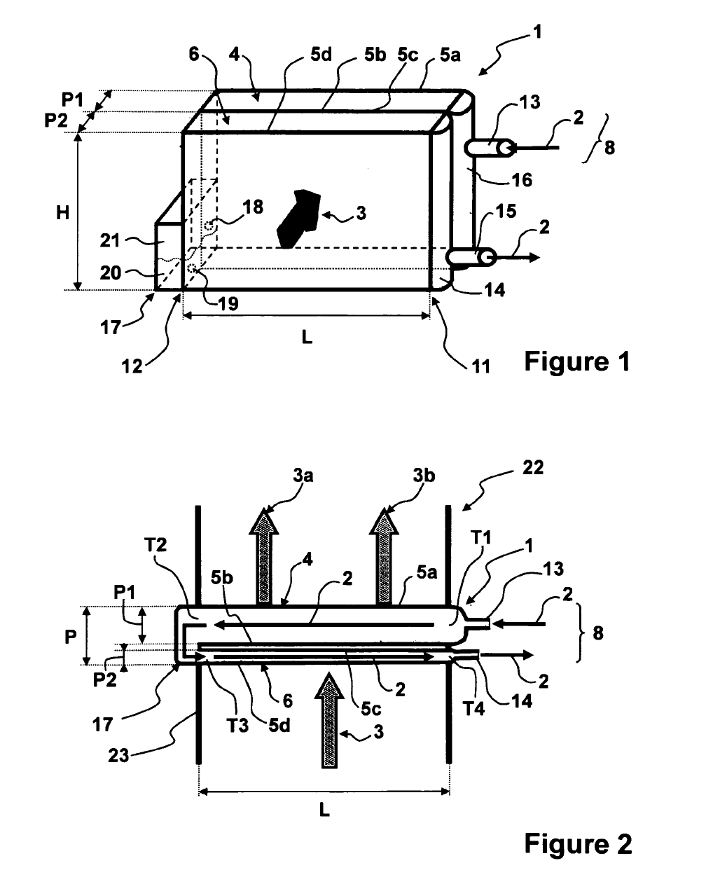

The present invention will be better understood and further features and advantages will become more apparent from reading the following detailed description comprising embodiments which are given by way of illustration with reference to the appended figures, which are presented by way of nonlimiting example and which could serve to supplement the understanding of the present invention and the explanation of how it is embodied and, if appropriate, contribute to defining it, and in which:
FIG. 1 is a schematic view of a heat exchanger according to the present invention, and
FIG. 2 is a partial view of a heating, ventilation and/or air-conditioning installation receiving the heat exchanger according to the present invention.

FIG. 1 illustrates the heat exchanger 1 according to an exemplary embodiment in accordance with the present invention. The heat exchanger 1 is intended to allow heat exchange between a coolant fluid 2, circulating in an air-conditioning loop, and a stream of interior air 3 intended to be distributed in a passenger compartment of a motor vehicle.

The heat exchanger 1 is very particularly intended to exchange between the stream of interior air and a coolant fluid designated HFO 1234YF. However, the present invention can also be applied in air-conditioning loops allowing the circulation of other subcritical fluids, for example a coolant fluid having the reference R134A, or of subcritical fluids, for example a coolant fluid having the reference R744A or CO2.

The heat exchanger 1 is a component of the air-conditioning loop intended to transfer the calories originating from the coolant fluid 2 toward the stream of interior air 3.

Advantageously, it carries out a function of heating the passenger compartment when the air-conditioning loop is configured in what is known as a “heating” mode. According to a preferred exemplary embodiment, the heat exchanger 1 is inactive when the air-conditioning loop is configured in what is known as a “cooling” mode.

The heat exchanger 1 comprises a first layer 4 and a second layer 6 in which the coolant fluid 2 circulates.

The first layer 4 is delimited by a first front face 5a and a second front face 5b. In addition, the second layer 6 is delimited by a third front face 5c and a fourth front face 5d.

According to a first variant, the first front face 5a, the second front face 5b, the third front face 5c and the fourth front face 5d are distinct from one another. In particular, the heat exchanger 1 is designed such that the second front face 5b and the third front face 5c are isolated, forming a space between one another.

According to another variant embodiment, two of the front faces are coincident. In particular, the heat exchanger 1 is designed such that the second front face 5b and the third front face 5c are identical and coincident. Thus, according to the present invention, at least three of the front faces are distinct and arranged in different planes.

In a complementary manner, the first front face 5a, the second front face 5b, the third front face 5c and the fourth front face 5d are parallel to one another.

In addition, the first front face 5a, the second front face 5b, the third front face 5c and the fourth front face 5d preferably define planes which are crossed by the stream of interior air 3. It is thus particularly advantageous for the stream of interior air 3 to cross in succession the fourth front face 5d, the third front face 5c, the second front face 5b and the first front face 5a. Thus, a preferred definition of the present invention is such that the second layer 6 is arranged upstream of the first layer 4 in the direction of flow of the stream of interior air 3.

It will thus be understood that the first layer 4 and the second layer 6 are installed alongside one another. Advantageously, the area of the first layer 4 is identical to the area of the second layer 6. Thus, it is apparent that the first front face 5a, the second front face 5b, the third front face 5c and the fourth front face 5d have identical areas.

Thus, depending on the direction of the stream of interior air 3, the first layer 4 and the second layer 6 are superposed.

In practice, the first layer 4 and the second layer 6 form two adjacent and parallel rows which together form a bundle 8 of the heat exchanger 1. The first layer 4 and the second layer 6 thus constitute a unitary block defining the bundle 8 of the heat exchanger 1.

Preferably, the first layer 4 and the second layer 6 are formed in an identical manner. They are each composed of a plurality of tubes each defining at least one circulation channel for the coolant fluid 2. The first layer 4 and the second layer 6 contribute to circulation of the coolant fluid 2 in the heat exchanger 1.

According to a particular exemplary embodiment, an insert for increasing the exchange area between the coolant fluid 2, circulating in the tubes, and the stream of interior air 3 is installed between two adjacent tubes of the first layer 4, or of the second layer 6, of the bundle 8 of the heat exchanger 1. The inserts are produced in a corrugated manner in order to form spaces in which the stream of interior air 3 circulates. The first layer 4, or the second layer 6, thus consists of an alternation of tubes and inserts.

As defined above, the first layer 4 extends over a first depth P1, a height H and a width L defining a first internal volume. Similarly, the second layer 6 extends over a second depth P2, a height H and a width L defining a second internal volume.

Consequently, the first depth P1 is the distance between the first front face 5a and the second front face 5b. Similarly, the second depth P2 is the distance between the third front face 5c and the fourth front face 5d. Preferably, the second depth P2 is less than the first depth P1.

Finally, the height H and the width L correspond to the heights and widths of the first front face 5a, the second front face 5b, the third front face 5c and the fourth front face 5d.

Thus, it is apparent that the tubes in the first layer 4 define a first volume of coolant fluid. Furthermore, the plurality of inserts in the first layer 4 define a first heat exchange volume. Similarly, the tubes in the second layer 6 define a second volume of coolant fluid. Furthermore, the plurality of inserts in the second layer 6 define a second heat exchange volume.

In a preferred variant of the present invention, the inserts in the first layer 4 are separate and isolated from the inserts in the second layer 6, so as to limit thermal bridges between the first layer 4 and the second layer 6. Alternatively, the heat exchanger 1 may comprise inserts which are common to the first layer 4 and to the second layer 6.

The heat exchanger 1 illustrated in FIG. 1 has a first end 11 and a second end 12, between which the bundle 8 extends.

According to the exemplary embodiment shown in FIG. 1, at the first end 11 there is an intake manifold 16 for the intake of coolant fluid 2 into the heat exchanger 1. The intake manifold 16 is secured to the bundle 8 so as to supply the plurality of tubes in the first layer 4 with coolant fluid 2. The coolant fluid 2 passes into the intake manifold 16 through an inlet pipe 13. For example, the inlet pipe 13 is formed by a duct connected to the intake manifold 16 and secured to the latter in a sealed manner.

Similarly, at the first end 11 there is a discharge manifold 14 for discharging the coolant fluid 2 from the heat exchanger 1. The discharge manifold 14 is secured to the bundle 8 so as to collect the coolant fluid 2 at the outlet from the plurality of tubes in the second layer 6. The coolant fluid 2 passes out of the discharge manifold 14 through an outlet pipe 15. For example, the outlet pipe 15 is formed by a duct connected to the discharge manifold 14 and secured to the latter in a sealed manner.

From the preceding text, it will be understood that the intake manifold 16 and the discharge manifold 14 are provided at the first end 11 of the heat exchanger 1. With this arrangement, it is apparent that the coolant fluid 2 circulates in what is known as a “U”-shaped circulation. Such an arrangement is significant with regard to the uniformity of the temperature downstream of the heat exchanger 1, depending on the direction of the stream of interior air 3.

Alternatively, the present invention is also applicable to heat exchangers 1 in which the intake manifold 16 and the discharge manifold 14 are arranged on either side of the bundle 8 of the heat exchanger 1, that is to say at the first end 11 and the second end 12.

The first layer 4 and the second layer 6 described above can be traversed in a plurality of passes that are organized such that the coolant fluid 2 circulates alternately in opposite directions. The directions of the passes of the first layer 4 and of the second layer 6 may in a horizontal direction, corresponding to the direction of extent of the heat exchanger 1 over the width L, and/or a vertical direction, corresponding to the direction of extent of the heat exchanger 1 over the height H.

The present invention can also be applied when the first layer 4 and/or the second layer 6 comprises a single pass, that is to say a circulation of the coolant fluid 2 in one direction, over the width L, over the entire height H of the first layer 4 and/or the second layer 6.

In addition, according to the present invention, a phase separation means 17 is arranged in the air-conditioning loop. The phase separation means 17 makes it possible to separate the liquid phase and the gas phase of the coolant fluid 2.

According to the preferred embodiment of the present invention, the phase separation means 17 is integrated in the heat exchanger 1. Alternatively, the phase separation means 17 may be the located in the air-conditioning loop and thus be separate from the heat exchanger 1.

The phase separation means 17 connects, from the point of view of the coolant fluid 2, the first layer 4 to the second layer 6. In other words, the phase separation means 17 is a component which allows the coolant fluid 2, originating from the first layer 4, to enter the second layer 6. It is thus placed downstream of the first layer 4 and upstream of the second layer 6 in the direction of circulation of the coolant fluid in the air-conditioning loop.

More specifically, the phase separation means 17 connects the first volume of coolant fluid of the first layer 4 to the second volume of coolant fluid of the second layer 6.

The coolant fluid 2 undergoes a cooling and/or condensation phase as it passes through the first layer 4. Consequently, the coolant fluid 2 passes into a two-phase state, a mixture of the liquid phase and the gas phase, in the phase separation means 17 via an outlet orifice 18 of the first layer 4.

The coolant fluid 2 in the liquid state thus collects a lower part of the phase separation means 17 and enters the second layer 6 through an inlet orifice 19. Advantageously, the inlet orifice 19 is positioned lower down than the outlet orifice 18 in the vertical direction, corresponding to the direction of extent of the heat exchanger 1 over the height H.

The phase separation means 17 comprises a collection zone 20 and a separation zone 21. The collection zone 20 is a volume intended to receive the coolant fluid 2 in the liquid state, while the separation zone 21 allows the coolant fluid 2 to split into a gas phase and a liquid phase. The separation zone 21 is connected to the first layer 4 by the outlet orifice 18, and the collection zone 20 is connected to the second layer 6 by the inlet orifice 19.

According to the present invention, the heat exchanger 1 is designed such that the second layer 6 produces a temperature difference of the coolant fluid 2 between the inlet orifice 19 and the outlet pipe 15 of the heat exchanger 1 of at least 30° C.

It will be understood here that the temperature of the coolant fluid 2 circulating in the second layer 6 is lowered by at least 30° C. as it travels through the second layer 6. This lowering in the temperature is measured for a situation in which the difference between the temperature of the stream of interior air 3 passing through the second layer 6 and the temperature of the coolant fluid 2 at the inlet orifice 19 of the second layer 6 is greater than or equal to 50° C.

Such a benefit is obtained in particular when the second internal volume of the second layer 6 is between 30% and 40% of the first internal volume of the first layer 4.

According to the present invention, the phase separation means 17 is not a device for storing the non-circulating mass of coolant fluid 2. The volume of the phase separation means 17 is thus reduced to the minimum necessary for ensuring that the second layer 6 is supplied with coolant fluid 2 in the liquid phase. Thus, a volume consisting of the volume of the phase separation means 17 and of the second volume of coolant fluid of the second layer 6 is advantageously between 40 and 50 cm³. This corresponds to an optimum for ensuring the separation function of the liquid phase and the gas phase without having an impact on the general exterior volume of the heat exchanger 1. Thus, it is possible to make it easier to integrate the heat exchanger 1 inside a housing of a heating, ventilation and/or air-conditioning installation of the vehicle.

FIG. 2 shows a partial view of a heating, ventilation and/or air-conditioning installation 22 receiving the heat exchanger 1 according to the present invention.

The heating, ventilation and/or air-conditioning installation 22 comprises a housing 23 for channeling the stream of interior air 3. The heat exchanger 1 according to the present invention is installed transversely with respect to the stream of interior air 3 in the housing 23, such that the stream of interior air 3 passes through the second layer 6 before the first layer 4. In other words, the second layer 6 is upstream of the first layer 4 in the direction of the stream of interior air 3.

In the present description, mention is made of a heating, ventilation and/or air-conditioning installation 22. Such a designation covers any type of installation housing the heat exchanger 1 according to the present invention. By way of example, it covers, in particular, heating and ventilation installations 22, which only distribute a stream of heated interior air, or heating, ventilation and/or air-conditioning installations 22 for the distribution of a stream of heated or cooled or temperature-controlled interior air.

An operating example emphasizing the homogeneous nature of the temperature of the stream of interior air 3 downstream of the heat exchanger 1 in the direction of the stream of interior air 3 will now be explained in detail.

It will be assumed that the temperature of the stream of interior air 3 entering the housing 23 is equal to 0° C. The coolant fluid 2 enters the heat exchanger 1 at a raised first temperature T₁, for example equal to 65° C., since the coolant fluid 2 is coming directly from the compressor, in which it has undergone an increase in pressure and temperature. It travels through the first layer 4 in which it exchanges heat with the stream of interior air 3. By virtue of this heat exchange, the coolant fluid 2 is cooled and/or condensed. The coolant fluid 2, thus cooled and/or condensed, then enters the phase separation means 17 at a second temperature T₂, which is lower than the first temperature T₁. The second temperature T₂ is, for example, equal to 50° C.

The coolant fluid 2 does not undergo heat exchange while passing through the phase separation means 17 and thus enters the second layer 6 at a third temperature T₃ equal to the second temperature T₂, or, according to the example given, 50° C., and in a liquid state.

The coolant fluid 2 in the liquid state then travels through the second layer 6 and undergoes a drop in temperature by exchange with the stream of interior air 3, to 0° C. according to the assumption chosen. The coolant fluid 2 then exits the heat exchanger 1 at a low fourth temperature T₄, for example equal to 20° C.

According to the present example, it will thus be noted that the second layer 6 carries out supercooling of the coolant fluid 2 by at least 30° C., corresponding to the difference between the third temperature T₃ and the fourth temperature T₄.

By virtue of the fact that the area of the first layer 4 is identical to the area of the second layer 6 and the fact that the second layer 6, in which the coolant fluid 2 is in the liquid state, is passed through by the stream of interior air 3 before the latter has passed through the first layer 4, in which the coolant fluid 2 is cooled and/or condensed, a stream of interior air is delivered downstream of the heat exchanger 1 at a uniform temperature.

Thus, the temperature of the stream of interior air 3a located opposite the inlet pipe 13, that is to say on the left-hand side in FIG. 2, is equal to 37.5° C., while the temperature of the stream of interior air 3b located next to the outlet pipe 15, that is to say on the right-hand side in FIG. 2, is equal to 37.5° C.

Such a heat exchanger 1 has dimensions suitable for its integration into the interior of the housing 23 of the heating, ventilation and/or air-conditioning installation 22. Preferably, the bundle 8, formed by the juxtaposition of the first layer 4 and the second layer 6, is such that:
the width L is between 100 mm and 300 mm,
the height H is between 120 mm and 300 mm, and
the depth P, corresponding to the sum of the first depth P1 and the second depth P2, is between 20 mm and 50 mm.

Consequently, the second depth P2 of the second layer 6 is preferably between 6 mm and 20 mm.

The heat exchanger 1 according to the present invention is one of the main components of the air-conditioning loop allowing the circulation of the coolant fluid 2.

The air-conditioning loop also comprises a compressor, an exterior heat exchanger, designed to ensure heat exchange between the coolant fluid 2 and a stream of exterior air with respect to the passenger compartment, in order to ensure a cooling and/or condensation function when the air-conditioning loop is operating in what is known as the “cooling” mode, or an evaporation function when the air-conditioning loop is operating in what is known as the “heating” mode.

The air-conditioning loop also comprises a means for storing coolant fluid 2, in particular a bottle, installed immediately downstream of the exterior heat exchanger in the direction of circulation of the coolant fluid, or an accumulator placed in the air-conditioning loop immediately upstream of the compressor.

The air-conditioning loop also comprises an interior heat exchanger, designed to carry out heat exchange between the coolant fluid 2 and the stream of interior air 3 intended to be distributed in the passenger compartment of the vehicle. The interior heat exchanger is intended to cool the stream of interior air 3 intended to be distributed in the passenger compartment when the circuit of the air-conditioning loop is operating in what is known as the “cooling” mode. Finally, the air-conditioning loop comprises at least one expansion member for lowering the pressure prior to the entry of the coolant fluid 2 into the interior heat exchanger.

Clearly, the invention is not limited to the embodiments described above and given purely by way of example. It encompasses various modifications, alternative forms and other variants which could be envisioned by a person skilled in the art within the scope of the present invention and in particular any combinations of the various modes of operation described above, which can be taken separately or in combination.

1. A heat exchanger designed to carry out heat exchange between a coolant fluid and a stream of interior air, comprising a bundle formed by a first layer and a second layer in which the coolant fluid circulates, the first layer being delimited by a first front face and a second front face and the second layer being delimited by a third front face and a fourth front face, wherein at least three of the first, second, third and fourth front faces are distinct and arranged in different planes.

2. The heat exchanger has claimed in claim 1, in which the first layer extends over a first depth and the second layer extends over a second depth.

3. The heat exchanger as claimed in claim 2, in which the sum of the first depth of the first layer and of the second depth of the second layer is between 20 and 50 mm.

4. The heat exchanger as claimed in claim 2, in which a height of the first layer is identical to a height of the second layer or in which a width of the first layer is identical to a width of the second layer.

5. The heat exchanger as claimed in claim 4, in which the height is between 120 and 300 mm or the width is between 100 and 300 mm.

6. The heat exchanger has claimed in claim 4, in which, with the first depth, the height and the width of the first layer define a first internal volume and with the second depth, the height and the width of the second layer define a second internal volume, wherein the second internal volume of the second layer his between 30% and 40% of the first internal volume of the first layer.

7. The heat exchanger as claimed in claim 1, further comprising a phase separation component connecting the first layer and the second layer of the heat exchanger.

8. The heat exchanger as claimed in claim 7, in which the first layer comprises a plurality of tubes defining a first volume of coolant fluid and a plurality of inserts defining a first heat exchange volume, and in which the second layer comprises a plurality of tubes defining a second volume of coolant fluid and a plurality of inserts defining a second heat exchange volume, the first volume of coolant fluid being placed in communication with the second volume of coolant fluid via the phase separation component.

9. The heat exchanger as claimed in claim 7, in which the first layer has an outlet orifice connected to the phase separation component, and in which the second layer has an inlet orifice connected to the phase separation component.

10. The heat exchanger as claimed in claim 7, in which the phase separation component comprises a collection zone intended to receive the coolant fluid in the liquid state, and in which the inlet orifice of the second layer is connected to the collection zone.

11. The heat exchanger has claimed in claim 7, in which the phase separation component and the second volume of coolant fluid of the second layer delimit an internal volume of between 40 cm³ and 50 cm³.

12. An air-conditioning loop for a motor vehicle comprising: a compressor; an exterior heat exchanger; a means for storing coolant fluid; an interior heat exchanger; and at least one expansion member; and a heat exchanger as claimed in claim 1, wherein the heat exchanger includes a phase separation component connecting the first layer and the second layer of the heat exchanger.

13. A heating, ventilation or air-conditioning installation for a motor vehicle comprising: a housing able to channel a stream of interior air intended to be distributed in a passenger compartment of the vehicle; and a heat exchanger as claimed in claim 1 installed in the housing, wherein the stream of interior air is able to pass through the heat exchanger.

14. The heat exchanger as claimed in claim 3, in which a height of the first layer is identical to a height of the second layer or in which a width of the first layer is identical to a width of the second layer.

15. The heat exchanger as claimed in claim 14, in which the height is between 120 and 300 mm or the width is between 100 and 300 mm.

16. The heat exchanger as claimed in claim 5, in which, with the first depth, the height and the width of the first layer define a first internal volume and with the second depth, the height and the width of the second layer define a second internal volume, wherein the second internal volume of the second layer is between 30% and 40% of the first internal volume of the first layer.

17. The heat exchanger as claimed in claim 15, in which, with the first depth, the height and the width of the first layer define a first internal volume and with the second depth, the height and the width of the second layer define a second internal volume, wherein the second internal volume of the second layer is between 30% and 40% of the first internal volume of the first layer.
